(19) United States
(12) Patent Application Publication
(10) Pub. No.: US 2007/0297450 A1
(43) Pub. Date: Dec. 27, 2007

(54) Method and apparatus for passing an application description to lower layer packet data protocol

(75) Inventors: Jeffrey C. Smolinske, Schaumburg, IL (US); Jyoti N. Black, St. Charles, IL (US); Kevin J. Kohnen, Algonquin, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/471,845

(22) Filed: Jun. 21, 2006

(51) Int. Cl. H04J 3/16

(52) U.S. Cl. 370/469; 370/392

(57) ABSTRACT

A packet data protocol system for a telecommunications system includes an application control layer (214) of the packet data protocol system (200), a lower layer of the packet data protocol system, and an information element (302) that includes an identification of an application to be run in the application control layer, the identification of the application provided to the lower layer of the packet data protocol system. The identification of the application (302) optionally includes an application description (304) and optionally an application version (306) for communicating a description of an application from the application control layer (214) to a lower layer of the packet data protocol system.

### FIELD OF THE INVENTION

The present invention relates generally to telecommunication systems. More specifically, but without limitation thereto, the present invention relates to a method and apparatus for communicating information between protocol layers in a telecommunications environment.

### BACKGROUND OF THE INVENTION

In a typical 3GPP (third generation General Partnership Project) radio communication system, applications such as push-to-talk over cellular (PoC) are performed by a layered packet data protocol (PDP). An advantage of a layered packet data protocol is that the modifications to one protocol layer may be made without requiring changes to the other protocol layers, resulting in a substantial savings in system maintenance resources. However, the advantage of a layered protocol may not necessarily ensure the optimum use of system resources.

Additionally, one disadvantage of a layered packet data protocol is that the identity of the application to be run by the mobile station (e.g., push-to-talk (PTT), push-to-talk over cellular (PoC), and voice over Internet protocol (VoIP)) for which the system resources are required is not seen by the lower layers of the layered packet data protocol. Thus, the lower level resources are not able to perform significant protocol optimizations in the Radio Link Control/Media Access Control (RLC/MAC) protocol and in the subnetwork-dependent convergence protocol (SNDCP).

### DESCRIPTION OF THE SEVERAL VIEWS OF THE DRAWINGS

The following drawings are presented by way of example and not limitation, wherein like references indicate similar elements throughout the several views of the drawings, and wherein:

FIG. 1 illustrates a diagram of a portion of a 3GPP telecommunication system of the prior art;

FIG. 2 illustrates a diagram of a 3GPP layered packet data protocol of the prior art;

FIG. 3 illustrates a diagram of the protocol stack of FIG. 2 modified to include an application description to optimize layered protocol performance in accordance with one embodiment;

FIG. 4 illustrates a diagram of the telecommunication system of FIG. 1 further including the path of the application description of FIG. 3 in accordance with one embodiment;

FIG. 5 illustrates a proposed Quality of Service (QoS) information element for the 3GPP TS 24.008 telecommunication standard in accordance with one embodiment;

FIG. 6 illustrates a flow chart of a method of passing the application description to a lower layer in the layered packet data protocol of FIG. 3 in accordance with one embodiment; and

FIG. 7 illustrates a flow chart of a method of passing the application description to a lower layer in the layered packet data protocol of FIG. 3 in accordance with another embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DESCRIPTION OF THE ILLUSTRATED EMBODIMENTS

The following description is not to be taken in a limiting sense, rather for the purpose of describing by specific examples the general principles that are incorporated into the illustrated embodiments. For example, certain actions or steps may be described or depicted in a specific order; however, practitioners of the art will understand that the specific order depicted is not a requirement. Also, the terms and expressions used in the description have the ordinary meanings accorded to such terms and expressions in the corresponding respective areas of inquiry and study except where other meanings have been specifically set forth herein.

Pursuant to the following teachings, in accordance with one embodiment, a layered packet data protocol (PDP) such as that defined by the 3GPP technical specification 23.060 may be modified as described below to communicate an application description from the application layer to the lower protocol layers in the packet data protocol (PDP) environment while maintaining the advantages of a layered protocol architecture. By passing an application description to lower layers of a layered packet data protocol, a substantial improvement in overall performance may be obtained with relatively minor protocol coupling compared to that resulting from political mechanisms, standards, backward compatibility, and deployment.

Various embodiments for passing an application description to a lower layer protocol system of a telecommunication system are provided. One embodiment includes a method comprising steps of executing an application in a telecommunications system, the step of executing the application occurring in the application control layer of the packet data protocol system; and communicating an identification of the application to a lower layer of the packet data protocol system.

Another embodiment includes a packet data protocol system of a telecommunications system comprising an application control layer of the packet data protocol system; a lower layer of the packet data protocol system; and an information element that includes an identification of an application to be run in the application control layer, the identification of the application provided to the lower layer of the packet data protocol system.

Prior to describing more details of various embodiments for communicating an application description from the application layer to the lower protocol layers in the packet data protocol (PDP) system, certain relevant aspects of telecommunication systems are briefly described.

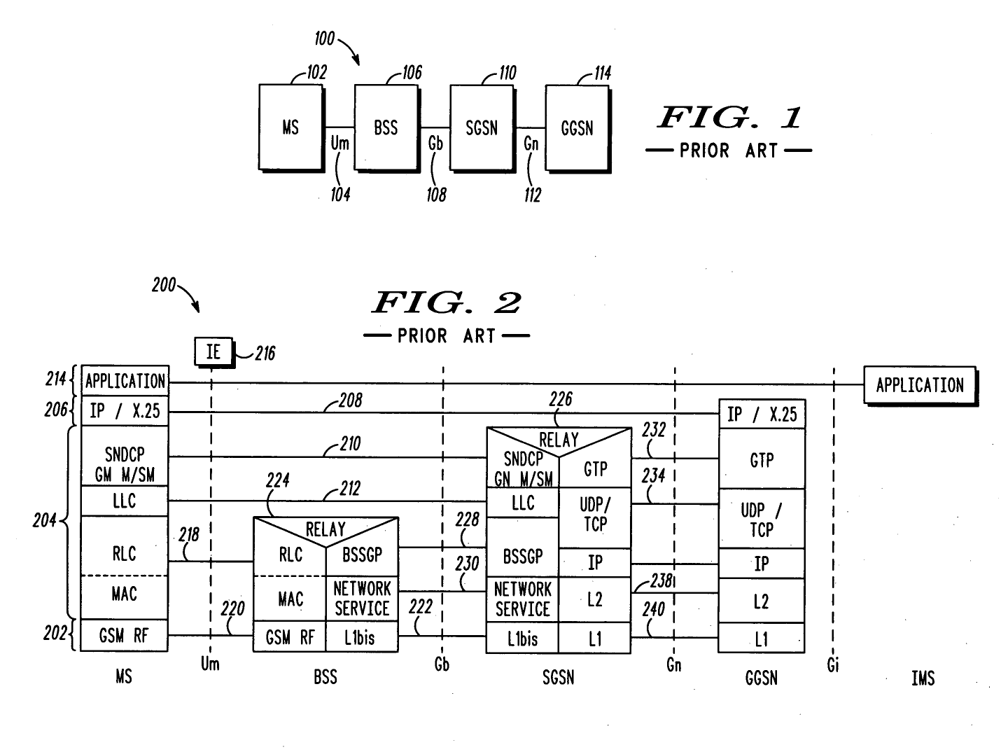

FIG. 1 illustrates a diagram of a portion of a 3GPP telecommunication system 100 of the prior art. Shown in FIG. 1 are a Mobile Station (MS) 102, a Um interface 104, a Base Station Subsystem (BSS) 106, a Gb interface 108, a Serving General Packet Radio Service (GPRS) Support Node (SGSN) 110, a Gn interface 112, and a Gateway GPRS Support Node (GGSN) 114.

In FIG. 1, the telecommunications system 100 includes the typical components shown as the Mobile Station (MS) 102, the Base Station Subsystem (BSS) 106, the Serving General Packet Radio Service (GPRS) Support Node (SGSN) 110, and the Gateway GPRS Support Node (GGSN) 114.

The Mobile Station (MS) 102 may be, for example, a mobile handset, a desktop computer, or any communication device used to send and/or receive messages in the telecommunication system 100 that is compatible with the 3GPP Global System for Mobile communications (GSM) standard. The Mobile Station (MS) 102 generates an ACTIVATE PDP CONTEXT REQUEST message including a Quality of Service (QoS) element or profile for each data session being started, which is defined in the telecommunication standard 3GPP TS 24.008 and is described in more detail below.

The Base Station Subsystem (BSS) 106 provides communication between the Mobile Station (MS) 102 and the Serving General Packet Radio Service (GPRS) Support Node (SGSN) 110 over the Gb interface 108.

The Serving General Packet Radio Service (GPRS) Support Node (SGSN) 110 caches (i.e., saves to a temporary memory location) and sends the Quality of Service (QoS) element or profile to the Gateway GPRS Support Node (GGSN) 114, and in some cases, with a change of the Serving GPRS Support Node (SGSN) 110, may retrieve the Quality of Service (QoS) profile from the Gateway GPRS Support Node (GGSN) 114 over the Gn interface 112. The Serving GPRS Support Node (SGSN) 110 may combine multiple Quality of Service (QoS) elements to form an Aggregate Base Station Subsystem (BSS) Quality of Service (QoS) Profile (ABQP) that is communicated to the Base Station Subsystem (BSS) 106.

The Gateway GPRS Support Node (GGSN) 114 stores the Quality of Service (QoS) element generated by the Mobile Station (MS) 102.

The Um interface 104 is a mobile air interface used to communicate between the Mobile Station (MS) 102 and the Base Station Subsystem (BSS) 106. The Gb interface 108 and the Gn interface 112 are General Packet Radio Service (GPRS) network interface protocols for communicating between the Base Station Subsystem (BSS) 106, the Serving General Packet Radio Service (GPRS) Support Node (SGSN) 110, and the Gateway GPRS Support Node (GGSN) 114.

FIG. 2 illustrates a diagram of a 3GPP layered packet data protocol system 200 of the prior art. Shown in FIG. 2 are a physical control layer (layer 1) 202, a data link control layer (layer 2) 204, a network control layer (layer 3) 206, an IP protocol 208, a Subnetwork Dependent Convergence Protocol (SNDCP)/GPRS Mobility Management (GMM)/Session Management (SM) protocol 210, a Logical Link Control (LLC) 212, an application control layer (layer 7) 214, a quality of service information element 216, a Radio Link Control (RLC)/Media Access Control (MAC) protocol 218, a GSM Radio Frequency Interface 220, an L1bis protocol 222, Relays 224 and 226, a Base Station System GPRS Protocol (BSSGP) 228, a Network Service (NS) 230, a GPRS Tunneling Protocol (GTP) 232, a User Datagram Protocol (UDP)/Transfer Control Protocol (TCP) 234, an L2 protocol 238, and an L1 protocol 240.

In FIG. 2, each of the layers 202, 204, 206, and 214 in the layered packet data protocol system 200 includes a group of functions to be utilized on the device on which it is running. The application control layer 214 includes syntax functions and special functions such as file transfer and interpretation of graphic functions. Additional layers that are not shown to simplify the illustration are a presentation control layer, a session control layer, and a transport control layer. The presentation control layer controls the formatting and display of data, data compression, and data decompression. The session control layer provides dialog coordination, formats data for end-to-end transfer, and provides restart and recovery functions. The transport control layer ensures reliable data transfer and end-to-end data integrity and also provides control of Transmission Control Protocol (TCP) functions.

The network control layer 206 includes more detailed rules for addressing and error control between networks and routing for Internet protocol messages.

The data link control layer 204 includes rules for error control and access within a network of the telecommunication system 100 in FIG. 1 and establishes communications links between the components of the telecommunication system 100. The Subnetwork Dependent Convergence Protocol (SNDCP) 210 maps network-level characteristics onto the underlying network as specified in 3GPP TS 44.065. The Logical Link Control (LLC) 212 provides a highly reliable ciphered logical link that is independent of the underlying radio interface protocols. This feature allows the introduction of alternative GPRS radio solutions with minimum changes to the Network Subsystem, specified in 3GPP TS 44.064. The Radio Link Control (RLC)/Media Access Control (MAC) protocol 218 provides two functions. The Radio Link Control (RLC) provides a reliable radio-solution-dependent link. The Media Access Control (MAC) controls the access signaling (request and grant) procedures for the radio channel and the mapping of LLC frames onto the GSM physical channel. The RLC/MAC protocol 218 is defined in 3GPP TS 44.060.

The physical control first layer 202 includes the GSM Radio Frequency interface protocol 220 and the L1bis protocol 222. The GSM Radio Frequency interface protocol 220 provides the physical radio link.

The Relay 224 in the Base Station System (BSS) 106 relays LLC Protocol Data Units (PDU) between the Um and Gb interfaces. The L1bis protocol 222 provides the physical medium between the base station system (BSS) 106 and the Serving General Packet Radio Service (GPRS) Support Node (SGSN) 110 in FIG. 1. The Base Station System GPRS Protocol (BSSGP) 228 conveys routing and Quality of Service (QoS) related information between the Base Station System 106 and the Serving General Packet Radio Service (GPRS) Support Node (SGSN) 110 in FIG. 1 as specified in 3GPP TS 48.018. The Network Service (NS) 230 transports Base Station System GPRS Protocol (BSSGP) PDU based on the Frame Relay connection between the Base Station System (BSS) 106 and the Serving General Packet Radio Service (GPRS) Support Node (SGSN) 110 in FIG. 1 as specified in GSM 08.16.

The Relay 226 relays Packet Data Protocol (PDP) PDU between the Gb and Gn interfaces in the Serving General Packet Radio Service (GPRS) Support Node (SGSN) 110. The GPRS Tunneling Protocol (GTP) 232 tunnels user data and signals between GPRS Support Nodes (GSN) in the GPRS backbone network. All Point to Point (PTP) Packet Data Protocol (PDP) Protocol Data Units (PDU) are encapsulated by the GPRS Tunneling Protocol (GTP) 232 as specified in GSM 09.60. The User Datagram Protocol (UDP) 234 carries GTP Protocol Data Units (PDU) for protocols that do not require a highly reliable data link, for example, Internet Protocol (IP). The User Datagram Protocol (UDP) 234 is defined in RFC 768. The L2 protocol 238 and the L1 protocol 240 may be any layer 2 and layer 1 protocols.

The information element 216 is generated by the Mobile Station (MS) 102 and contains information about the Quality of Service (QoS) resources required for an application such as push-to-talk (PTT), push-to-talk over cellular (PoC), and voice over Internet protocol (VoIP). Examples of information in the information element 216 include a quality of service information element identifier, a length of the quality of service information element, a peak throughput, a maximum uplink bit rate, a maximum downlink bit rate, a guaranteed uplink bit rate, and a guaranteed downlink bit rate. The maximum bit rate is the upper limit on the bit rate that a user or application can accept or provide. The guaranteed bit rate describes the bit rate the bearer service guarantees to the user or application. The guaranteed bit rate may be used to facilitate admission control based on available resources, and for resource allocation within the system.

After the information element 216 is generated by the Mobile Station (MS) 102, the information element 216 is propagated through the Base Station Subsystem (BSS) 106 to the Serving General Packet Radio Service (GPRS) Support Node (SGSN) 110 over the Gb interface 108 and to the Gateway GPRS Support Node (GGSN) 114 over the Gn interface 112. The information element 216 is cached and sent to the Gateway GPRS Support Node (GGSN) 114 where it is stored. Upon an inter-SGSN cell change, the information element 216 is retrieved from the Gateway GPRS Support Node (GGSN) 114 and cached by the new Serving GPRS Support Node (SGSN) 110. The Serving General Packet Radio Service (GPRS) Support Node (SGSN) 110 combines multiple Quality of Service (QoS) elements to form an Aggregate Base Station Subsystem (BSS) Quality of Service (QoS) Profile (ABQP) that is communicated to the Base Station Subsystem (BSS) 106.

A disadvantage of the layered packet data protocol system 200 is that the identity of the application to be run by the mobile station 102 for which the system resources are required is not seen by the lower layers of the layered packet data protocol system 200. If the identity of the application were known to the lower layers of the protocol stack 200, the Base Station Subsystem (BSS) 106 and the Serving GPRS Support Node (SGSN) 110 could perform significant protocol optimizations in the Radio Link Control/Media Access Control (RLC/MAC) protocol 218 and in the subnetwork-dependent convergence protocol (SNDCP) 210 of layer 2. The lack of information about the application to be run in the application control seventh layer (layer 7) 214 may be advantageously overcome by modifying the Packet Data Protocol (PDP) to include an application description in an information element as described below.

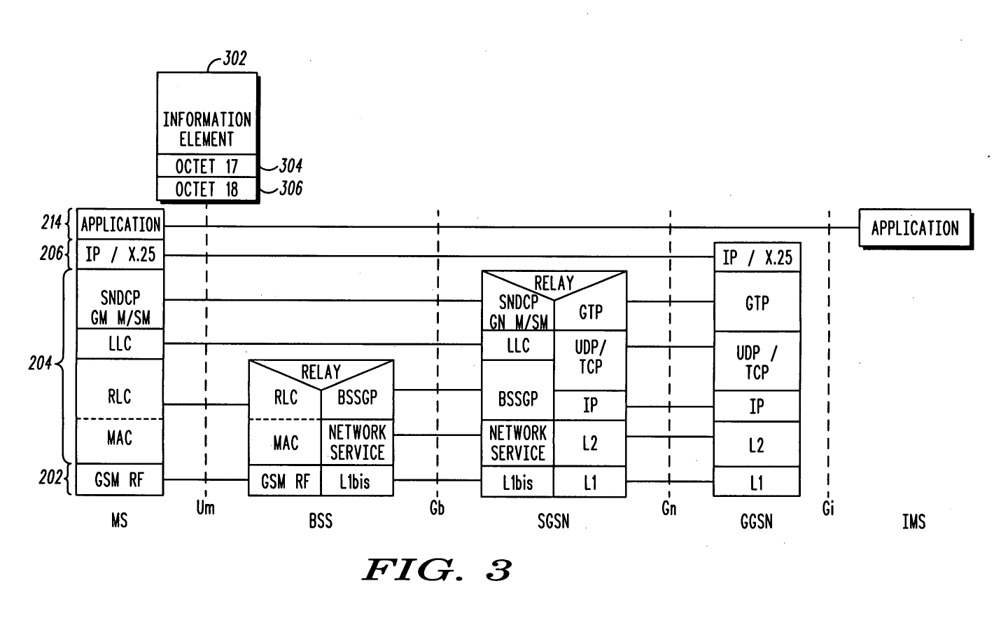

FIG. 3 illustrates a diagram of the layered packet data protocol of FIG. 2 modified to include an application description to optimize layered protocol performance. Shown in FIG. 3 are a physical control layer 202, a data link control layer 204, a network control layer 206, an application control layer 214, an information element 302, an application description 304, and an application version 306.

In FIG. 3, in accordance with one embodiment, the information element 302 is identical to the information element 216, except that the information element 302 has been modified to include the application description 304 and the application version 306. The application description 304 may be, for example, an octet (eight-bit number) in the information element 302 that identifies the application to be run by the Mobile Station 102 in the application control seventh layer 214. The application version 306 is also included to identify the version of the application if desired. The application version 306 may be, for example, an octet. Examples of applications that may be identified in the application description 304 and a corresponding exemplary octet for each application include data transfer (Data) 00₁₆, push-to-talk (PTT) 01₁₆, push-to-talk with data transfer (PTT+Data) 02₁₆, push-to-talk over cellular (PoC) 04₁₆, push-to-talk over cellular with data transfer (PoC+Data) 05₁₆, Voice over Internet protocol (VoIP) 06₁₆, and Voice over Internet protocol with data transfer (VoIP+Data) 07₁₆. The application description 304 and the application version 306 are available to application-related functions in the lower layers of the layered packet data protocol that may use the information to optimize overall performance of the telecommunication system for each application to be run in the application control layer 214, while other functions may ignore the information.

In operation, the application layer 214 provides data about the identification of the application to the data link control layer 204. The identification of the application can include an application description and an application version. The GMM in the data link control layer 204 then generates the information element 216 including the identification of the application. For example, in one embodiment, the information element 216 includes the application description 304 and the application version 306. The information element then propagates through the packet data protocol system as shown by path 350. The information element including the identification of the application eventually is received by the BSS allowing the Base Station Subsystem (BSS) 106 and the Serving GPRS Support Node (SGSN) 110 to perform significant protocol optimizations in the Radio Link Control/Media Access Control (RLC/MAC) protocol 218 and in the subnetwork-dependent convergence protocol (SNDCP) 210 of layer 2.

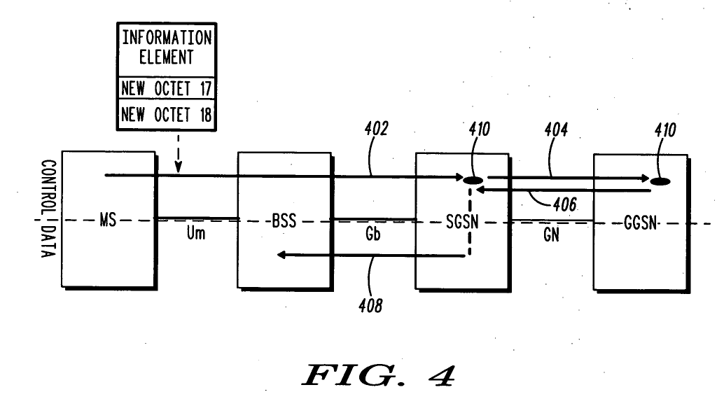

FIG. 4 illustrates a diagram of the telecommunication system of FIG. 1 further including the information element of FIG. 3. Shown in FIG. 4 are a Mobile Station (MS) 102, a Um interface 104, a Base Station Subsystem (BSS) 106, a Gb interface 108, a Serving General Packet Radio Service (GPRS) Support Node (SGSN) 110, a Gn interface 112, a Gateway GPRS Support Node (GGSN) 114, an information element 302, and application description 304, an application version number 306, control paths 402, 404, and 406, a user data path 408, and a user profile 410.

In FIG. 4, the information element 302 is identical to the information element 216 in FIG. 2, except that the information element 302 includes the application description 304 and the application version number 306 in the new octets 17 and 18. Thus, in accordance with one embodiment, Applicants proposed a change to the QoS Profile information element sent over the Um, Gb, and Gn interfaces in the 3GPP TS 24.008 telecommunication standard. Applicants propose extending the length of the information element by two new octets, octet 17 for the application description 304 and octet 18 for the application version 306. Applicants also propose, in accordance with one embodiment, changing FIG. 10.5.156/3GPP TS 24.008 to include the definitions of octet 17 for the application description 304 and octet 18 for the application version 306. Each application description 304 can be assigned a different 8 bit code and each application version 306 for each of the different application descriptions can be assigned a different 8 bit code. The codes for the application version are dependent upon the application description.

After the information element 302 is generated by the Mobile Station (MS) 102, the information element 302 is propagated through the Base Station Subsystem (BSS) 106 to the Serving General Packet Radio Service (GPRS) Support Node (SGSN) 110 over the Gb interface 108 along the control path 402 where it is cached before being sent to the Gateway GPRS Support Node (GGSN) 114 over the Gn interface 114 along the control path 404. The information element 302 is stored as the user profile 410 in the Gateway GPRS Support Node (GGSN) 114 where it is retrieved and cached when needed by the Serving General Packet Radio Service (GPRS) Support Node (SGSN) 110, for example, upon an inter-SGSN cell change, by the new Serving General Packet Radio Service (GPRS) Support Node (SGSN) 110. The Serving General Packet Radio Service (GPRS) Support Node (SGSN) 110 combines multiple Quality of Service (QoS) elements to form an Aggregate Base Station Subsystem (BSS) Quality of Service (QoS) Profile (ABQP) that is communicated to the Base Station Subsystem (BSS) 106 along the user data path 408.

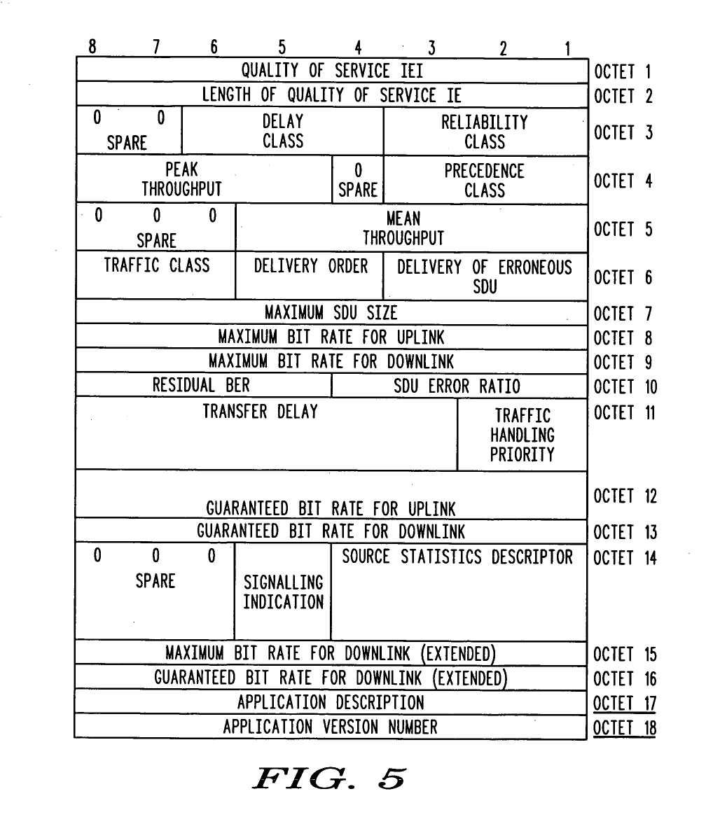

FIG. 5 illustrates a proposed Quality of Service (QoS) information element for the 3GPP TS 24.008 telecommunication standard in accordance with one embodiment. In one embodiment, it is proposed that FIG. 5 replaces the FIG. 10.5.138 in 3GPP TS 24.008. The information element includes the addition of octet 17 for the application description 304 and octet 18 for the application version 306.

Some of the other octets include a quality of service information element identifier (octet 1), a length of the quality of service information element (octet 2), a peak throughput (octet 4), a maximum uplink bit rate (octet 8), a maximum downlink bit rate (octet 9), a guaranteed uplink bit rate (octet 12), and a guaranteed downlink bit rate (octet 13).

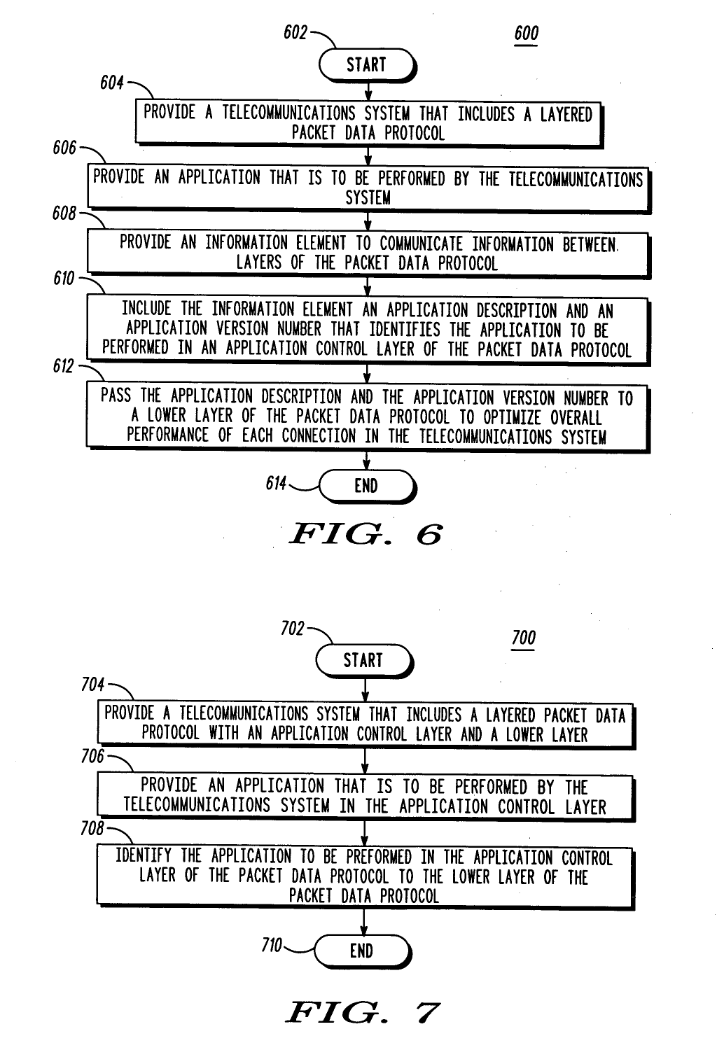

FIG. 6 illustrates a flow chart of a method of passing the application description to a lower layer in the layered packet data protocol of FIG. 3 in accordance with one embodiment. Step 602 is the entry point of the flow chart 600.

In step 604, a telecommunications system is provided that includes a layered packet data protocol system, for example, the telecommunications system of FIG. 4 described above.

In step 606, an application is provided that is to be performed by the telecommunications system. In one embodiment, the application is running within the telecommunications system in the application control layer. Examples of an application include data transfer (Data), push-to-talk (PTT), push-to-talk with data transfer (PTT+Data), push-to-talk over cellular (PoC), push-to-talk over cellular with data transfer (PoC+Data), Voice over Internet protocol (VoIP), Voice over Internet protocol with data transfer, Multimedia Broadcast/Multimedia Service, Real-time Streaming Video, and Non-real time Video.

In step 608, an identification of the application is communicated from the application control layer to one or more lower layers of the packet data protocol system.

In step 610, in accordance with some embodiments, an application description 304 and an application version number 306 of the application to be performed in an application layer of the packet data protocol are included in an information element 302. By way of example, the application description 304 and the application version number 304 may be embodied as two added bytes in the information element 302.

In step 612, the application description 304 and the application version number 306 are propagated through the packet data protocol system to optimize overall performance of each connection in the telecommunications system. For example, the information element 302 specifying the Quality of Service (QoS) information may be communicated to the session management control layer. The session management control layer then passes the application description 304 and the application version number 306 included in the information element 302 to one or more lower layers of the packet data protocol system.

Step 614 is the exit point of the flow chart 600.

Although the flowchart description above is described and shown with reference to specific steps performed in a specific order, these steps may be combined, subdivided, or reordered without departing from the scope of the claims. Unless specifically indicated, the order and grouping of steps is not a limitation of other embodiments that may lie within the scope of the claims.

The flow chart of FIG. 6 may also be implemented by instructions for being performed on a computer or other programmable or partially programmable platform. The instructions may be embodied in ROM, RAM, disk, CD-ROM, and other computer readable media according to well-known computer programming techniques.

A computer program product in accordance with one embodiment includes: a medium for embodying a computer program for input to a computer; and a computer program embodied in the medium for causing the computer to perform steps of: executing an application in a telecommunications system, the step of executing the application occurring in the application control layer of a packet data protocol system; and communicating an identification of the application to a lower layer of the packet data protocol system.

FIG. 7 illustrates a flow chart of a method of passing the application description to a lower layer in the layered packet data protocol of FIG. 3 in accordance with another embodiment.

Step 702 is the entry point of the flow chart 700.

In step 704, a telecommunications system is provided including a layered packet data protocol system. The layered packet data protocol system includes an application control layer and at least one lower layer, for example, as described above with respect to FIG. 4.

In step 706, an application to be performed by the telecommunications system in the application control layer is provided, for example, data transfer, push-to-talk, push-to-talk with data transfer, push-to-talk over cellular, push-to-talk over cellular with data transfer, Voice over Internet protocol, Voice over Internet protocol with data transfer, Multimedia Broadcast/Multimedia Service, Real-time Streaming Video, and Non-real time Video. In one embodiment, the application is running within the telecommunications system in the application control layer.

In step 708, the application to be performed in the application control layer of the packet data protocol system is identified to the lower layer of the packet data protocol system. Following the lower layer packages the identification of the application in an information element 302 passed between layers of the packet data protocol system, for example, by an application description 304 and an application version number 306 embodied in the added bytes 17 and 18 of the information element as described above.

Step 710 is the exit point of the flow chart 700.

As may be appreciated from the method of passing an application description to lower layers of a layered packet data protocol described above, a substantial improvement in overall performance may be obtained while maintaining most of the advantages of a layered packet data protocol.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

What is claimed is:

1. A method comprising steps of:
executing an application in a telecommunications system, the step of executing the application occurring in the application control layer of a packet data protocol system; and
communicating an identification of the application to a lower layer of the packet data protocol system.

2. The method of claim 1 further comprising generating an information element in the lower layer of the packet data protocol system, the information element includes the identification of the application and wherein the identification of the application includes an application description.

3. The method of claim 2 further comprising:
specifying a quality of service information element identifier, a length of the quality of service information element, a peak throughput, a maximum uplink bit rate, a maximum downlink bit rate, a guaranteed maximum uplink bit rate, and a guaranteed maximum downlink bit rate in the information element.

4. The method of claim 2 further comprising including the identification of the application in at least one octet in the information element.

5. The method of claim 1 wherein the application comprises one of the group consisting of data transfer, push-to-talk, push-to-talk with data transfer, push-to-talk over cellular, push-to-talk over cellular with data transfer, Voice over Internet protocol, Voice over Internet protocol with data transfer, Multimedia Broadcast/Multimedia Service, Real-time Streaming Video, and Non-real time Video.

6. The method of claim 1 further comprising generating an information element in the lower layer of the packet data protocol system, the information element includes the identification of the application and wherein the identification of the application includes an application version.

7. The method of claim 6 further comprising:
specifying a quality of service information element identifier, a length of the quality of service information element, a peak throughput, a maximum uplink bit rate, a maximum downlink bit rate, a guaranteed maximum uplink bit rate, and a guaranteed maximum downlink bit rate in the information element.

8. The method of claim 6 comprising including the identification of the application in at least one octet in the information element.

9. A computer program product comprising:
a medium for embodying a computer program for input to a computer; and
a computer program embodied in the medium for causing the computer to perform steps of:
executing an application in a telecommunications system, the step of executing the application occurring in the application control layer of a packet data protocol system; and
communicating an identification of the application to a lower layer of the packet data protocol system.

10. The computer program product of claim 9 wherein the computer is further caused to perform the step of generating an information element in the lower layer of the packet data protocol system, the information element includes the identification of the application and wherein the identification of the application includes at least one of an application description and an application version number.

11. The computer program product of claim 10 wherein the computer further is caused to perform the step of specifying a quality of service information element identifier, a a peak throughput, a maximum uplink bit rate, a maximum downlink bit rate, a guaranteed maximum uplink bit rate, and a guaranteed maximum downlink bit rate in the information element.

12. The computer program product of claim 10 wherein the identification of the application is included in at least one octet in the information element.

13. The computer program product of claim 11 wherein the application comprises one of the group consisting of data transfer, push-to-talk, push-to-talk with data transfer, push-to-talk over cellular, push-to-talk over cellular with data transfer, Voice over Internet protocol, Voice over Internet protocol with data transfer, Multimedia Broadcast/Multimedia Service, Real-time Streaming Video, and Non-real time Video.

14. A packet data protocol system of a telecommunications system comprising:
an application control layer of the packet data protocol system;
a lower layer of the packet data protocol system; and
an information element that includes an identification of an application to be run in the application control layer, the identification of the application provided to the lower layer of the packet data protocol system.

15. The packet data protocol system of claim 14 wherein the identification of the application includes an application description.

16. The packet data protocol system of claim 15 wherein the identification of the application includes an application version number.

17. The packet data protocol system of claim 15 wherein the application description identifies the application as one of the group consisting of data transfer, push-to-talk, push-to-talk with data transfer, push-to-talk over cellular, push-to-talk over cellular with data transfer, Voice over Internet protocol, Voice over Internet protocol with data transfer, Multimedia Broadcast/Multimedia Service, Real-time Streaming Video, and Non-real time Video.

18. The packet data protocol system of claim 14 wherein the information element comprises an information element identifier, a length of the information element, a peak throughput, a maximum uplink bit rate, a maximum downlink bit rate, a guaranteed maximum uplink bit rate, and a guaranteed maximum downlink bit rate.

19. The packet data protocol system of claim 14 wherein the identification of the application is provided to the lower layer of the packet data protocol system from the application layer of the packet data protocol system.
